(19) United States
(12) Patent Application Publication
(10) Pub. No.: US 2007/0130327 A1
(43) Pub. Date: Jun. 7, 2007

(54) Browser system and method for warning users of potentially fraudulent websites

(76) Inventors: Cynthia Y. Kuo, Pittsburgh, PA (US); Fritz J. Schneider, San Francisco, CA (US); Collin E. Jackson, Seattle, WA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/295,291

(22) Filed: Dec. 5, 2005

(51) Int. Cl. G06F 15/173

(52) U.S. Cl. 709/224

(57) ABSTRACT

A user is warned of a potentially fraudulent document, such as a webpage, by a warning message that is overlaid on top of the document and of the browser chrome. The warning message is associated with a warning icon displayed in the browser chrome. The potentially fraudulent document is rendered in the browser such that the links within are not accessible to the user. The rendering may include superimposing an image over the document or rendering a snapshot of the document instead of the document itself.

### TECHNICAL FIELD

The disclosed embodiments relate generally to online security and, more particularly, to alerting online users to potentially fraudulent websites.

### BACKGROUND

Today, users of the Internet face many threats to their online security. One of the fastest growing of these security threats is the phenomenon of phishing. Phishing involves the fraudulent acquisition of sensitive information, such as login information or financial information, by a perpetrator masquerading as a trustworthy source.

One attempt to reduce the damage caused by phishing involves warning a user if a webpage visited by the user is determined to be potentially fraudulent. The warning may be in the form of a pop-up window. However, many users have developed an aversion to pop-up windows due to their association with unsolicited advertisements. These users may end up ignoring and closing the pop-up warning windows, not knowing that the pop-up windows contain genuine security warnings rather than unsolicited advertisements. As a result, the users are left vulnerable to the threat posed by potentially fraudulent webpages. It may be noted that warning messages conveyed by system dialog windows are also regularly ignored by many users, sometimes to their detriment.

Accordingly, it is desirable to provide a more effective manner of warning users of potentially fraudulent websites.

### SUMMARY

In accordance with some embodiments, a method of alerting a user to a potentially fraudulent document includes determining that a document requested by a user is potentially fraudulent; displaying a non-interactive rendering of the document; displaying a warning icon; and displaying a warning message corresponding to the warning icon.

In accordance with some embodiments, instructions for the aforementioned method may be included in a computer program product.

### BRIEF DESCRIPTION OF THE DRAWINGS

FIG. 1 is a block diagram illustrating a network, in accordance with some embodiments.

FIGS. 2A-2F are flow diagrams illustrating processes for warning a user of a potentially fraudulent website, in accordance with some embodiments.

FIG. 3 is a diagram illustrating a browser application window with a warning of a potentially fraudulent website, in accordance with some embodiments.

FIG. 4 is a block diagram illustrating a client, in accordance with some embodiments.

FIG. 5 is a block diagram illustrating a server, in accordance with some embodiments.

Like reference numerals refer to corresponding parts throughout the drawings.

### DESCRIPTION OF EMBODIMENTS

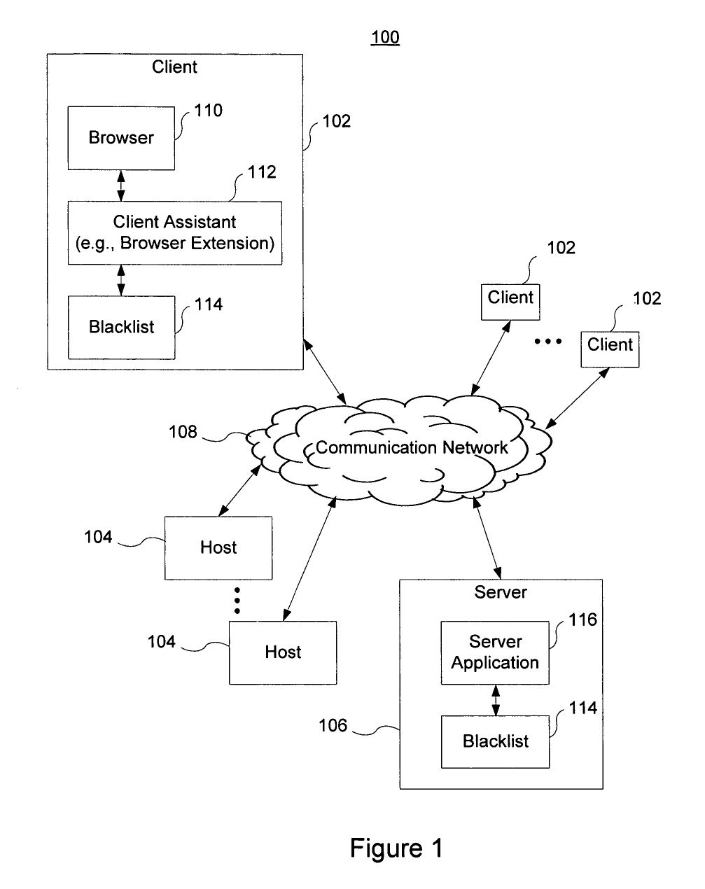

FIG. 1 is a block diagram illustrating a network, in accordance with some embodiments. The network 100 includes one or more clients 102, one or more hosts 104, a server 106, and a network 108 that couples these components. The network 108 may include one or more of the following: local area networks (LAN), wide area networks (WAN), intranets, wireless networks, and the Internet. The clients 102 may include, but is not limited to, personal computers (PC), network terminals, mobile phones, and personal digital assistants (PDA).

The hosts 104 store documents and provide the documents to the clients 102 or the server 106. A document stored at a host 104 may include text, graphics, multimedia, or any combination thereof. In some embodiments, the document is a webpage written in Hypertext Markup Language (HTML) or any other language suitable for coding webpages. Each document may be located and/or identified by a locator or address. In some embodiments, the locator is the Uniform Resource Locator (URL) of the document. In other embodiments, other addressing formats may be used.

The client 102 may include a browser 110, a client assistant 112, and a blacklist 114. From the browser 110 (or other application, such as an email client), a user of the client 102 may request a document at a specified URL. The document is downloaded to the client 102 and rendered in the browser 110 for display. The client assistant 112 performs operations, such as document rendering or document request operations, in conjunction with the browser 110. In some embodiments, the client assistant 112 is a browser extension. In some other embodiments, the client assistant 112 is a plug-in or toolbar add-on to the browser 110.

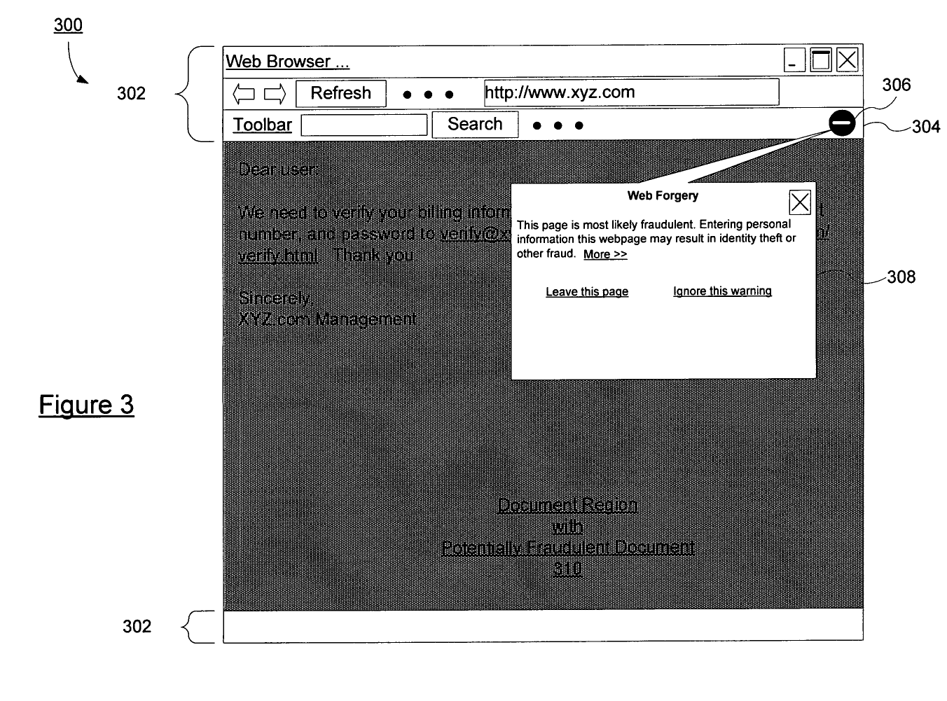

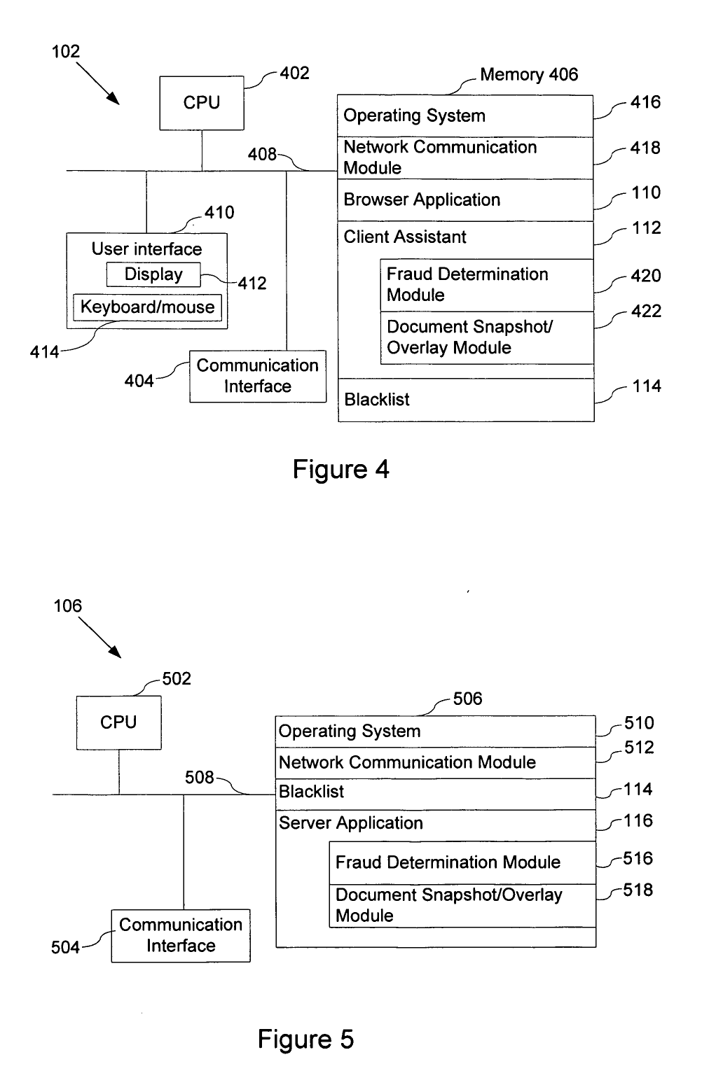

A window of the browser 110, when displayed at the client 102 via an output device such as a display 412 (FIG. 4), includes a plurality of display regions. One of these regions is the document region, where a document, such as a webpage requested by the user, is displayed. Display regions of the browser window other than the document region constitute the privileged display regions of the browser window. These privileged regions are reserved for displaying menus, toolbars, buttons, titles, status information, and the like. These privileged regions are sometimes collectively known in the art as the chrome of the browser. Further details about the document and privileged regions are described below, in relation to FIG. 3.

The blacklist 114 includes a list of URLs and/or groups of URLs (e.g., specified by URL patterns) of documents that are known to be fraudulent. The blacklist may include URLs, or URL patterns (e.g., www.badoperator.com/*) that are suspected to be fraudulent (e.g., on the basis of unconfirmed user reports), and which therefore may be considered to be potentially fraudulent. A document with a URL that is in the blacklist 114 may be determined to be potentially fraudulent. The blacklist 114 may specify particular documents or groups of documents under specified domains or paths. In some embodiments, the blacklist 114 at the client 102 is a copy of a “master” blacklist 114 that is stored at the server 106. A copy of the blacklist 114 may be downloaded periodically (e.g., daily) or episodically (e.g., when the client 102 performs a specific action, such as logging into a particular service, or connecting to the Internet), from the server 106 and stored locally at the client 102. Optionally, a user may create a customized blacklist 114, for example by modifying a blacklist downloaded from the server 106 or other source, or by creating a new blacklist.

In some embodiments, when a user requests a document from a host 104, the client assistant 112 determines whether the document is potentially fraudulent, by comparing the URL of the document to the blacklist 114 or by other methods, such as by heuristic evaluation. Such heuristics may include heuristics that take into account the age of the domain (e.g., domains less than N days old may be more likely to contain fraudulent web pages than older domains; N may be a number between 1 and 30), the physical location (e.g., the country) of the domain name owner, similarity of the URL to a legitimate URL that is often targeted, PageRank status of the URL, and so on. Other heuristics include comparing a fingerprint of a document's content or document structure with the fingerprints of known targets, and identifying documents that contains the logos of known targets. If the URL of the document matches an entry in the blacklist 114 and/or if the document is heuristically evaluated to be potentially fraudulent, the document is determined to be potentially fraudulent. The client assistant 112 may perform operations to warn the user that the document is potentially fraudulent, further details of which are described below.

The server 106 includes a server application 116 and a blacklist 114. In some embodiments, the blacklist 114 at the server 106 is the master copy. The blacklist 114 may be updated by the server application 116 periodically or whenever a new report of a potentially fraudulent document is received. Clients 102 may download a copy of the master blacklist 114 from the server 106 for local storage and use.

In some embodiments, the determination of whether a document is potentially fraudulent may be performed at the server 106, by the server application 116. Whenever a user requests a document at a client 102, the client assistant 112 may transmit the URL of the requested document to the server 106. The server application 116 may compare the URL with the blacklist 114, or it may download the document from the host 104 and perform a heuristic evaluation to determine if the document is potentially fraudulent. If the document is determined to be potentially fraudulent, the server application 116 may instruct the client assistant 112 to perform operations toward warning the user that the document is potentially fraudulent, further details of which are described below.

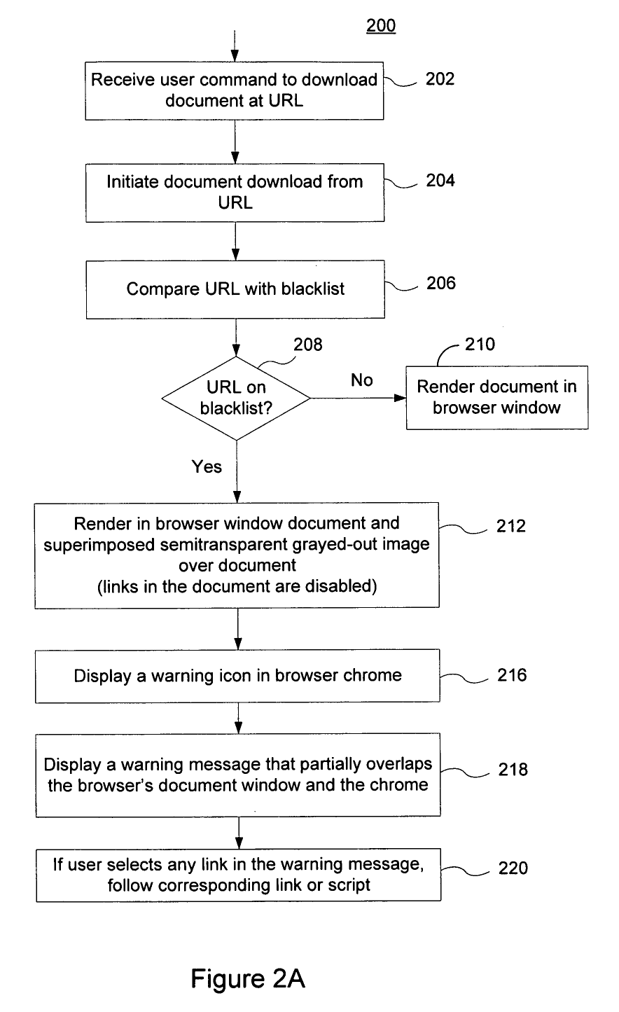

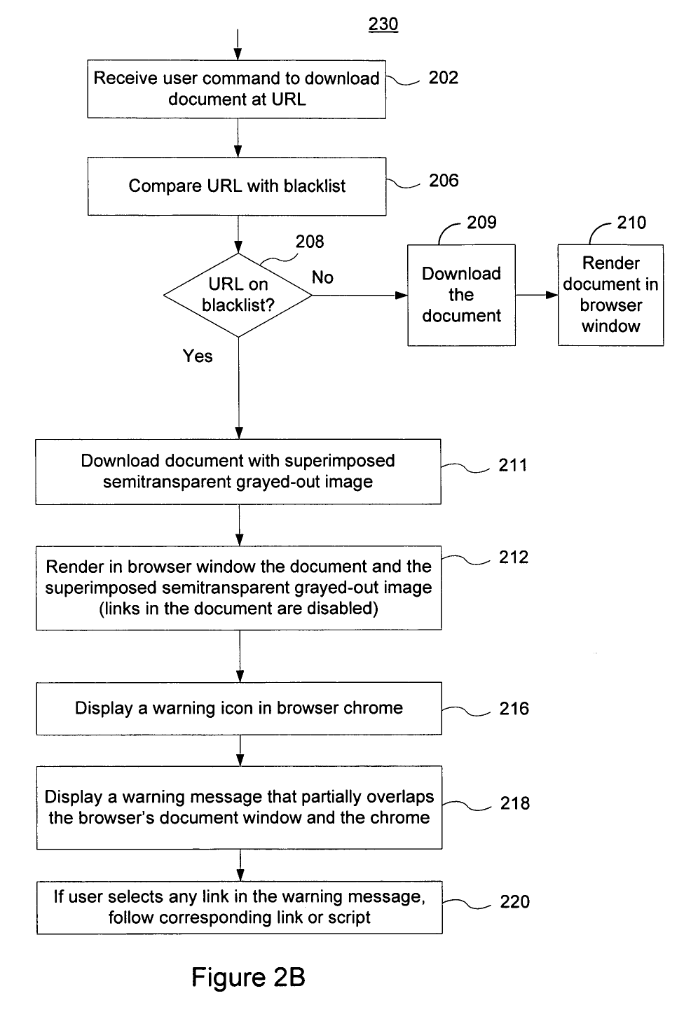

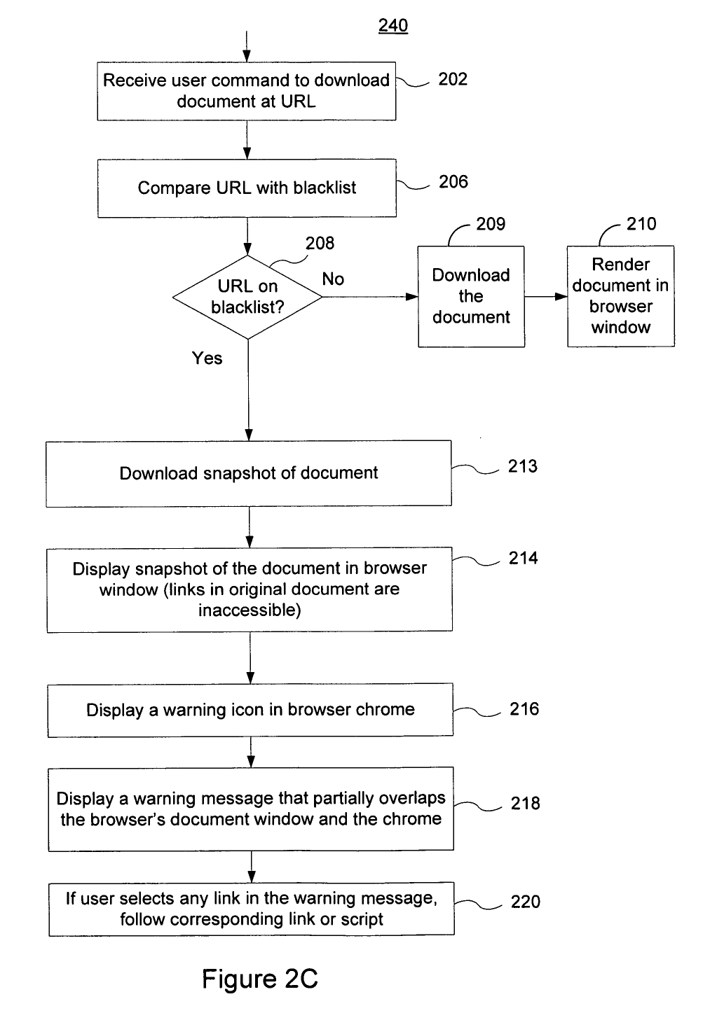

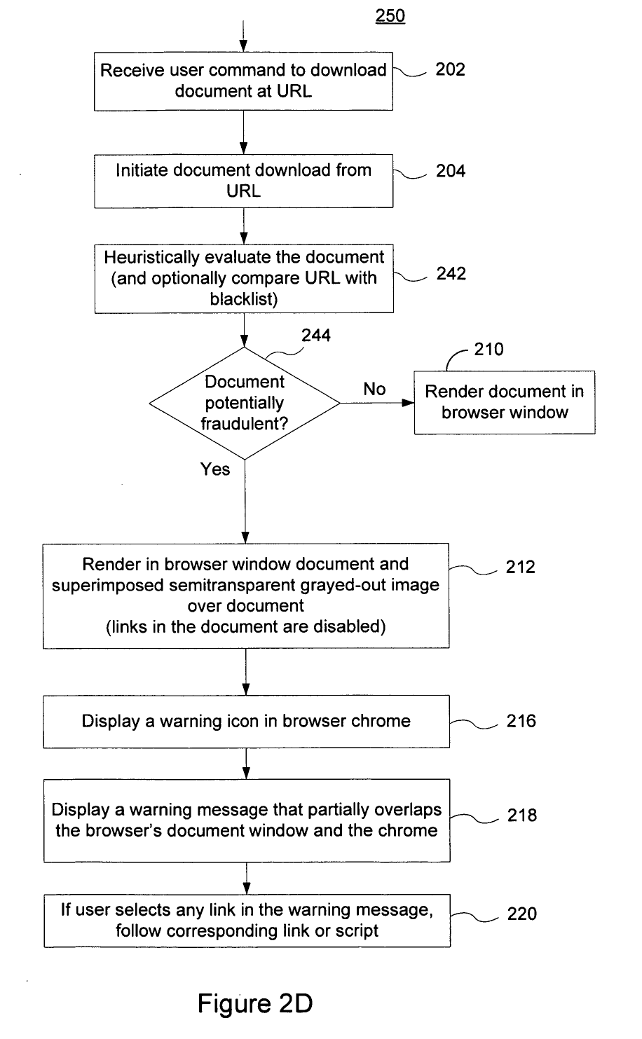

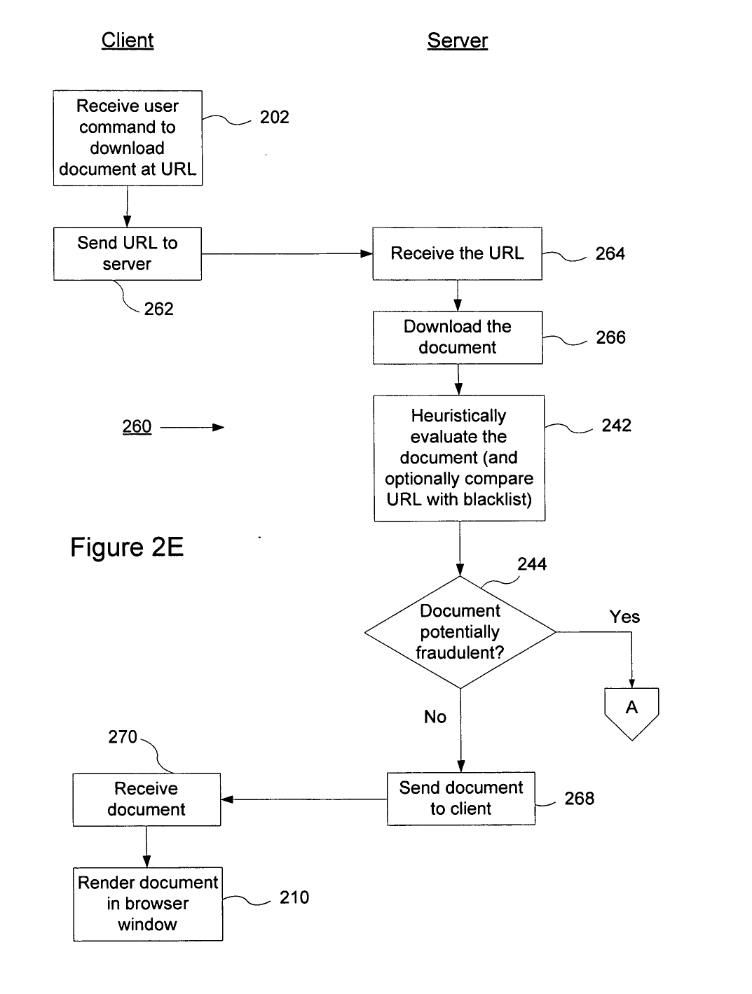

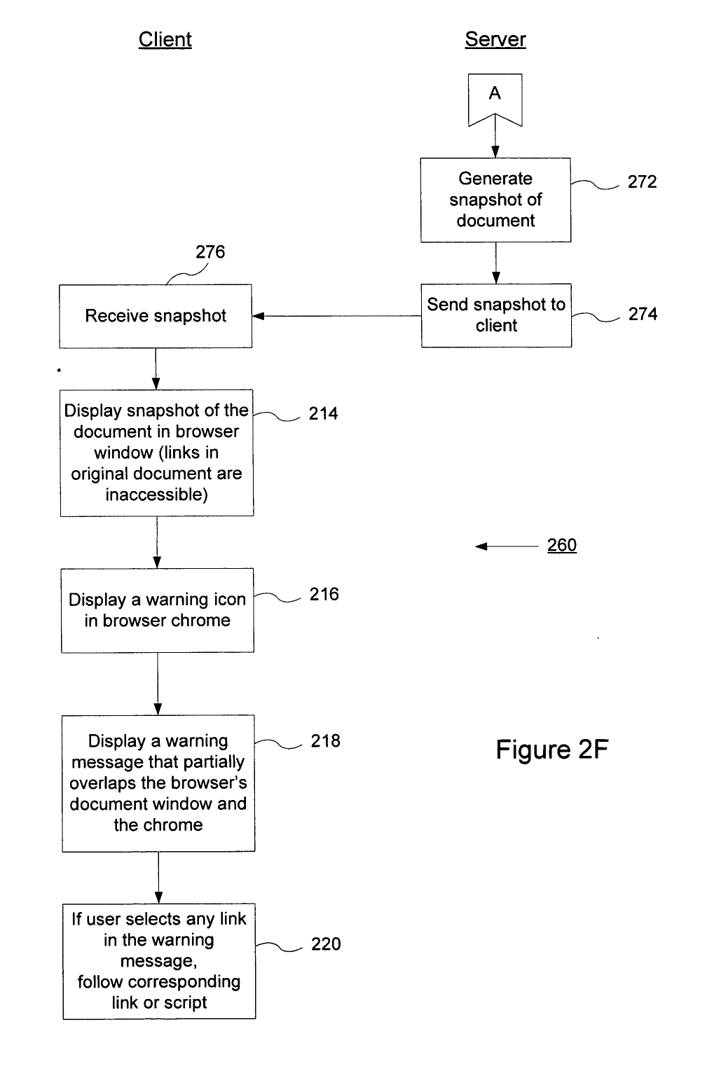

FIGS. 2A-2F are flow diagrams illustrating processes for warning a user of a potentially fraudulent website, in accordance with some embodiments. In process flow 200, which in some embodiments may be performed entirely by a client, a user command to download a document is received at a client (202). In some embodiments, the document is identified by its URL. The user command may be entered by the user at a client 102 by typing in the URL of the document in a browser application or selecting a link to the document. The link may be located in a web page, an email message, an IM message, a word processing document, spreadsheet document, or in any another document or client application that supports links to documents.

A download of the document to the client is initiated (204). The URL of the document is compared to the blacklist (206). In some embodiments, the client assistant 112 performs the comparison of the document URL to the blacklist.

If the URL of the document is not in the blacklist (208—no), the document is determined to be not potentially fraudulent. The document is rendered in the browser window and displayed normally (210).

While FIG. 2A shows blocks 204 and 206 as operations performed serially, it should be appreciated that blocks 204 and 206 may be performed in parallel.

If the URL of the document is in the blacklist (208—yes), the document is determined to be potentially fraudulent. The document is rendered and displayed in the browser window with an image superimposed (or overlaid) on top of the document (212). In some embodiments, the image is superimposed on top of the document by the client assistant 112.

In some embodiments, the superimposed image may be a semitransparent image that is entirely of a gray color. When the gray image is superimposed onto the document, it gives the visual effect that the document is “grayed out.” In some other embodiments, the image may be a “no” sign (e.g., an enclosure, such as a circle, with a strikethrough or an X inside) superimposed on top of the document. The superimposition of the image makes any links in the rendered document inaccessible to the user; in effect, the rendered document is made non-interactive. By making the links in the document inaccessible to the user, the user is prevented from performing potentially insecure actions, such as submitting personal information, via those links. In some embodiments, making a document non-interactive also prevents keystroke or other user input of information into any input fields of the document. Furthermore, in some embodiments, making a document non-interactive prevents the execution of any scripts or other executable instructions in the document. It should be appreciated, however, that the aforementioned examples of the image to be superimposed over the document described above are merely exemplary. The image may take on forms other than what is described above. 6

A warning icon is displayed in a privileged display region, such as the browser chrome, of the browser window (216). In some embodiments, the warning icon is displayed in an area of the chrome of the browser window reserved for displaying objects associated with the client assistant 112, sometimes called a toolbar (if above the document display region) or tray (if below the document display region). The icon may take on any suitable form, such as a stop sign, an exclamation mark inside an enclosure, or the like. In some embodiments, more than one warning icon may be displayed in order to better get the user's attention.

A warning message is displayed (218). The warning message is displayed such that it overlays and partially overlaps the document region (e.g., 310 in FIG. 3), in which the document and the superimposed image are displayed, and the browser chrome (e.g., 302 in FIG. 3). Furthermore, the warning message is displayed such that it is prominently associated with the warning icon. In some embodiments, the association of the warning message with the warning icon is shown by the warning message pointing towards the warning icon. In some embodiments, the warning message may include links to leave the requested document and go to another document (such as the user's default home page) or to ignore the warning and to proceed with the requested document. In some other embodiments, the warning message may further include links to scripts, such as a reporting script for reporting a document as fraudulent. In embodiments in which the client assistant applies heuristics or other measures to identify a potentially fraudulent page, the reporting script may report to the server the URL of the document, and may optionally send to the server computed information about the document (e.g., a content fingerprint or other fingerprints), and/or portions of the document (e.g., a list of URLs referenced by links in the document, and/or headings in the document). If the user selects any of the links in the warning message, the corresponding link or script is followed (220). Furthermore, the warning message need not be limited to an image. For example, in some embodiments, the warning message includes a sound, or a combination of an image with a sound.

Process flow 230, as shown in FIG. 2B, illustrates an alternative embodiment that is similar to process flow 200. A user command to download a document at a specified URL is received at a client 102 (202). The URL is compared to the blacklist (206). If the URL is not on the blacklist (208—no), the document is downloaded by the browser (209) and rendered and displayed in the browser window (210).

If the URL is in the blacklist (208—yes), the document with a superimposed image is downloaded (211). As described above, the image may be a gray, semitransparent image or a “no” sign. The client 102 may download the document with the image from the server 106. The client 102 (or more particularly, the client assistant 112) sends a request to the server 106 for the document with the image superimposed. The server 106 downloads the document from the host 104 of the document, superimposes the image onto the document, and sends the document and the image to the client 102.

After the client 102 receives the document with the superimposed image, the document and the image are rendered and displayed in the browser window (212). The warning icon is displayed in the privileged display region of the browser (216). The warning message is displayed (218). Corresponding links or scripts in the warning message are followed if selected by the user (220).

Process flow 240, as shown in FIG. 2C, illustrates an alternative embodiment that is similar to process flow 230. Only the aspects of process flow 240 that differ from process flow 230 will be described. In particular, in this embodiment, if the requested URL is in the blacklist (208—yes), a graphical facsimile (a “snapshot”) of the document is downloaded (213) from a server. The snapshot is an image file that portrays what the document looks like when rendered normally in a browser. The snapshot does not contain any active links, and therefore any links that were in the document are not accessible to the user in the snapshot. As described above, making the links inaccessible prevents the user from performing potentially insecure actions (e.g., entering information into input fields of the document, or clicking on links in the document). Furthermore, the snapshot does not include any of the scripts or other executable instructions of the document at the URL. As a result, in this embodiment, making a document non-interactive prevents execution (e.g., at the client 102) of any scripts or other executable instructions in the document. In some embodiments, the client 102 may download the snapshot from the server 106. The client 102 sends a request to the server 106 for a snapshot of the document. The server 106 downloads the document from the host 104 of the document, generates the snapshot of the document, and sends the snapshot to the client 102. In some other embodiments, the client 102 may download the document from the host 104 and the client assistant 112 generates the snapshot.

After the client 102 receives the snapshot of the document, the snapshot is rendered and displayed in the browser window (214). The warning icon is displayed in the privileged display region of the browser (216). The warning message is displayed (218). Corresponding links or scripts are followed if selected by the user (220).

Process flow 250, as shown in FIG. 2D, illustrates an alternative embodiment that is similar to process flow 200. In this embodiment, operations 206 and 208 of process flow 200 are replaced by operations 242 and 244. After a download of the document is initiated (204), the document is heuristically evaluated by the client assistant 112 (242). The heuristic evaluation involves analyzing the content of the document to determine if the document is potentially fraudulent. In some embodiments, the URL of the document may optionally be compared to the blacklist. If the document is determined to be not potentially fraudulent (244—no), the document is rendered and displayed in the browser window (210). If the document is determined to be potentially fraudulent (244—yes), the document is rendered and displayed with an image superimposed on top (212).

In some embodiments, both operation 206 and operation 242 are performed, thereby performing both a blacklist comparison (202) and a heuristic analysis of the document (242). Alternately, the heuristic analysis (242) is performed only if the document's URL is not found in the blacklist. If the document passes both tests, it is rendered in the browse window (210); otherwise, operations 212-220 are performed, as described above.

Process flow 260, as shown in FIGS. 2E-2F, illustrates an alternative embodiment where the determination of whether the document is potentially fraudulent is performed by the server. A user command to download a document is received at a client 102 (202). The URL of the document is sent to a server 106 (262). The server 106 receives the URL (264). The server 106 downloads the document from the host of the document (266). The document is heuristically evaluated by the server application 116 (242). The heuristic evaluation involves analyzing the content of the document to determine if the document is potentially fraudulent. In some embodiments, the URL of the document may optionally be compared to the blacklist.

If the document is determined to be not potentially fraudulent (244—no), the document is sent to the client 102 (268). The client 102 receives the document (270) and the document is rendered and displayed in the browser window (210).

If the document is determined to be potentially fraudulent (244—yes), a snapshot of the document is generated by the server application 116 (272, FIG. 2F). The snapshot is sent to the client 102 (274). The client 102 receives the snapshot (276). The snapshot is rendered and displayed in the browser window (214). The warning icon is displayed in the privileged display region of the browser (216). The warning message is displayed (218). Corresponding links or scripts are followed if selected by the user (220).

FIG. 3 is a diagram illustrating a browser application window with a warning of a potentially fraudulent website, in accordance with some embodiments. The window of a browser application 300 includes the privileged display region(s) 302 and a document region 310. The privileged display region 302 is sometimes known in the art as the chrome of the browser window. The privileged display region 302 may be sub-divided into sub-regions, such as sub-regions for a title bar, menu bar, status bar, navigation buttons, tabs, and a sub-region for objects associated with the client assistant 112, such as an add-on toolbar 304.

The document region 310 is the region where a rendered document or a snapshot of a document may be displayed. In FIG. 3, a potentially fraudulent document is displayed in the document region 310 with a gray, semi-transparent image superimposed on top. A warning icon 306 is displayed in the toolbar 304. A warning message box 308 is displayed in the window 300, overlaying portions of the document region 310 and the privileged display region 302. The warning message 308 overlays and overlaps parts of both the document region 310 and the toolbar 304. The warning message box 308 points to the warning icon 306, signifying their association and drawing the user's attention to both the warning icon and the warning message. Because the warning message box 308 overlaps parts of both the document region 310 and the toolbar 304, and because it points to the warning icon, it has a distinctly different appearance than a pop-up window. The graying out of the document and the inactivation of the link, in combination with the warning icon and warning message are designed to ensure that the user does not treat the warning message as an ordinary (and thus unimportant) pop-up window.

FIG. 4 is a block diagram of a client, in accordance with some embodiments. The client 102 generally includes one or more processing units (CPU's) 402, one or more network or other communications interfaces 404, memory 406, and one or more communication buses 408 for coupling these components. The client 102 may optionally include a user interface 410, for instance a display 412 and a keyboard/mouse 414. Memory 406 may include random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The communication buses 408 may include circuitry (sometimes called a chipset) that interconnects and controls communications between system components. Memory 406 may include mass storage that is remotely located from the central processing unit(s) 402.

In some embodiments, memory 406 stores the following programs, modules and data structures, or a subset thereof:
an operating system 416 that includes procedures for handling various basic system services and for performing hardware dependent tasks;
a network communication module 418 that is used for connecting the client 102 to other computers via the one or more communication network interfaces 404 (wired or wireless) and one or more communication networks (108, FIG. 1), such as the Internet, other wide area networks, local area networks, metropolitan area networks, and so on;
a browser application 110;
a client assistant 112; and
a blacklist 114.

The client assistant 112 includes a fraud determination module 420 and a document snapshot/overlay module 422. The fraud determination module 420 determines if a document is potentially fraudulent, by comparing the URL of the document to the blacklist 114 and/or performing a heuristic evaluation of the document. The document snapshot/overlay module 422 generates snapshots of documents or superimposes documents with images that disable the links in the documents. The document snapshot/overlay module may also render documents with images superimposed or snapshots of documents, in conjunction with the browser application 110. In other embodiments, as described above, the client assistant 112 may send the URL of a document to a server for evaluation.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 406 may store a subset of the modules and data structures identified above. Furthermore, memory 406 may store additional modules and data structures not described above.

FIG. 5 is a block diagram illustrating a server, in accordance with some embodiments. The server 106 typically includes one or more processing units (CPU's) 502, one or more network or other communications interfaces 504, memory 506, and one or more communication buses 508 for coupling these components. The server 106 optionally may include a user interface comprising a display device and a keyboard/mouse (not shown). Memory 506 includes random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPU(s) 502. In some embodiments, memory 506 stores the following programs, modules and data structures, or a subset thereof:
an operating system 510 that includes procedures for handling various basic system services and for performing hardware dependent tasks;
a network communication module 512 that is used for connecting the server 106 to other computers via the one or more communication network interfaces 504 (wired or wireless), such as the Internet, other wide area networks, local area networks, metropolitan area networks, and so on;
a blacklist 114; and
a server application 116.

The server application 116 may optionally include a fraud determination module 516 and a document snapshot/overlay module 518. The fraud determination module 516 determines if a document is potentially fraudulent, by comparing the URL of the document to the blacklist 114 and/or performing a heuristic evaluation of the document. The document snapshot/overlay module 518 generates snapshots of documents or superimposes documents with images that disable the links in the documents. These snapshots of documents or documents with superimposed images may be sent to the client 102.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 506 may store a subset of the modules and data structures identified above. Furthermore, memory 506 may store additional modules and data structures not described above.

Although FIG. 5 shows a server, FIG. 5 is intended more as functional description of the various features which may be present in a set of servers than as a structural schematic of the embodiments described herein. In practice, and as recognized by those of ordinary skill in the art, items shown separately could be combined and some items could be separated. For example, some items shown separately in FIG. 5 could be implemented on single servers and single items could be implemented by one or more servers. The actual number of servers used to implement a server and how features are allocated among them will vary from one implementation to another, and may depend in part on the amount of data traffic that the system must handle during peak usage periods as well as during average usage periods.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of alerting a user to a potentially fraudulent document, comprising:
determining that a document requested by a user is potentially fraudulent;
displaying a non-interactive rendering of the document;
displaying a warning icon; and
displaying a warning message corresponding to the warning icon.

2. The method of claim 1, wherein determining comprises comparing a locator of the document to a blacklist of locators of potentially fraudulent documents.

3. The method of claim 1, wherein determining comprises determining, based on heuristics, that the document is potentially fraudulent.

4. The method of claim 1, wherein displaying the non-interactive rendering comprises displaying a semitransparent overlay over the document.

5. The method of claim 1, wherein displaying the non-interactive rendering comprises displaying a graphical facsimile of a rendering of the document.

6. The method of claim 1, wherein displaying the warning icon comprises displaying the warning icon in a privileged display region of a browser application.

7. The method of claim 1, wherein displaying the warning message comprises displaying the warning message so as to overlay both a portion of the displayed non-interactive rendering of the document and a portion of a privileged display region of a browser application.

8. The method of claim 1, wherein displaying the warning message comprises displaying the warning message whereby the warning message overlays a portion of the displayed non-interactive rendering of the document and is anchored to the warning icon; and
displaying the warning icon comprises displaying the warning icon in a privileged display region of a browser application.

9. The method of claim 1, wherein the method is performed entirely by a client device.

10. A system for alerting a user to a potentially fraudulent document, comprising:
a fraudulent document determination module, including instructions to determine that a document requested by a user is potentially fraudulent;
a document rendering module, including instructions:
to display a non-interactive rendering of the document;
to display a warning icon; and
to display a warning message corresponding to the warning icon.

11. A computer program product for use in conjunction with a computer system, the computer program product comprising a computer readable storage medium and a computer program mechanism embedded therein, the computer program mechanism comprising instructions for:
determining that a document requested by a user is potentially fraudulent;
displaying a non-interactive rendering of the document;
displaying a warning icon; and
displaying a warning message corresponding to the warning icon.

12. The computer program product of claim 11, wherein the instructions for determining comprise instructions for matching a locator of the document to a blacklist of locators of potentially fraudulent documents.

13. The computer program product of claim 11, wherein the instructions for determining comprise instructions for determining, based on heuristics, that the document is potentially fraudulent.

14. The computer program product of claim 11, wherein the instructions for displaying the non-interactive rendering comprise instructions for displaying a semitransparent overlay over the document.

15. The computer program product of claim 11, wherein the instructions for displaying the non-interactive rendering comprise instructions for displaying a graphical facsimile of a rendering of the document.

16. The computer program product of claim 11, wherein the instructions for displaying the warning icon comprise instructions for displaying the warning icon in a privileged display region of a browser application.

17. The computer program product of claim 11, wherein the instructions for displaying the warning message comprise instructions for displaying the warning message so as to overlay both a portion of the displayed non-interactive rendering of the document and a portion of a privileged display region of a browser application.

18. The computer program product of claim 11, wherein the instructions for displaying the warning message comprise instructions displaying the warning message whereby the warning message overlays a portion of the displayed non-interactive rendering of the document and is anchored to the warning icon; and
the instructions for displaying the warning icon comprise instructions for displaying the warning icon in a privileged display region of a browser application.

19. A system for alerting a user to a potentially fraudulent document, comprising:
means for determining that a document requested by a user is potentially fraudulent;
means for displaying a non-interactive rendering of the document;
means for displaying a warning icon; and
means for displaying a warning message corresponding to the warning icon.
